(19) United States
(12) Patent Application Publication
(10) Pub. No.: US 2018/0170154 A1
(43) Pub. Date: Jun. 21, 2018

(54) FLUSH GLAZED DEVICE FOR VEHICLE DOOR HAVING A MOVABLE PANEL WITH X-WISE LOCKING MEANS, CORRESPONDING SHOE, DOOR AND MOTOR VEHICLE

(71) Applicant: ADVANCED COMFORT SYSTEMS FRANCE SAS - ACS FRANCE, Bressuire (FR)

(72) Inventor: Philippe CHARGE, Bressuire (FR)

(21) Appl. No.: 15/740,582

(22) PCT Filed: Dec. 14, 2016
(86) PCT No.: PCT/EP2016/081067

§ 371 Date: Dec. 28, 2017

(30) Foreign Application Priority Data
Mar. 15, 2016 (FR) 1652205
Apr. 26, 2016 (FR) 1653690

(51) Int. Cl. B60J 1/17; B60J 5/04

(52) U.S. Cl. CPC B60J 1/17; B60J 10/79; E05Y 2900/55; B60J 5/0402

(57) ABSTRACT

The invention relates to a glazed device intended to be assembled to a bodywork casing (11) in order to form a motor vehicle door, comprising at least one movable glazed panel (121) that bears, on its face oriented towards the inside of the vehicle, at least one guide shoe (25) each of which is mounted so as to slide with respect to a guide rail (22A). Said guide rail (22A) has a guide portion of substantially circular cross section, having a radius R1, that is open to allow the passage of a connecting portion of at least one of said shoes (25), and at least one of said shoes has at least one portion for locking in the longitudinal direction of said vehicle (X), substantially ovoid and having a maximum radius R2 that is substantially greater than the radius R1, said locking portion being deformable so as to pass into said guide portion of the rail.

### FIELD OF THE INVENTION

The field of the invention is that of motor vehicles. More precisely, the invention relates to vehicle doors, and in particular the equipment of openings arranged in such doors.

Further more precisely, the invention relates to vehicle doors provided with at least one substantially vertically movable glazed panel, in particular in order to pass from a closed position to an open position wherein it penetrates fully or partially into a lower bodywork casing (with the movable panel able, of course, to generally have, a plurality of intermediate positions).

Such a vehicle door can in particular be a side door, but the invention can also apply, for example, to swing doors and/or sliding doors of a vehicle, including the rear doors, tailgates, etc.

The invention relates in particular to a glazed device, intended to be assembled to a bodywork casing in order to form a vehicle door, wherein on the glazed surface is flush, i.e. according to which no frame appears seen from the outside.

### PRIOR ART

Examples of such devices are described in particular in the documents of patent EP 1 422 091 and EP 1 612 072.

According to this approach, a frame is provided, on the side oriented towards the inside of the vehicle, bearing one or several (conventionally two) rails, cooperating with shoes integral with the movable glazed panel, and fixed on the face of the latter oriented towards the inside of the vehicle. The frame can, where applicable, be truncated and be limited to uprights bearing the rails.

This technique is interesting, as it makes it possible to create original designs, thanks to the suppression of the conventional door frame, which still retaining an effective guiding and maintaining of the movable panel. An improved version of this approach is proposed in patent document FR 3 021 254, in the name of the applicant of this patent application, and which describes a simple and effective adjustment of the shoes, making it possible to obtain a precise and predetermined guiding, provided by the rails and the shoes, despite the relatively substantial tolerances that can exist, from one vehicle to another.

However, other problems with mounting, assembling and guiding can appear, in particular due to the position of the window in relation to the wheel cover placed on the rail. The position of the latter and/or of the glazed panel must take account of tolerances and allowances, but the latter are not always compatible with an additional allowance according to the longitudinal direction of the vehicle (direction X) for the displacement of the glazed panel.

There is therefore a need to control the X-wise position of the glazed panel, and to guarantee that the guiding thereof takes place without an allowance (or at the very least with a very small allowance).

### Objectives of the Invention

The invention has in particular for objective to respond to this need.

More precisely, an objective of the invention is to provide a glazed device for the carrying out of a vehicle door, which allows for a simple and effective guiding of the glazed panel, without an allowance or with a highly reduced allowance in the direction X.

Another objective of the invention is to provide such a glazed device that is simple to implement and to assemble, for example, on an assembly line.

### DESCRIPTION OF THE INVENTION

This objective, as well as others that shall appear intended to be assembled to a bodywork casing in order to form a motor vehicle door, comprising at least one movable glazed panel that bears, on its face oriented towards the inside of the vehicle, at least one guide shoe each mounted so as to slide with respect to a guide rail.

According to the invention, said guide rail has a guide portion of substantially circular cross section, having a radius R1, that is open to allow the passage of a connecting portion of at least one of said shoes, and at least one of said shoes has at least one portion for locking in the longitudinal direction of said vehicle (X), substantially ovoid and having a maximum radius R2 that is substantially greater than the radius R1, said locking portion being deformable so as to pass into said guide portion of the rail.

As such, this portion for locking locks all X-wise displacement. Of course, the locking exists only in the direction X, and it authorises a guiding in the direction Z (height of the vehicle) and where applicable in the lateral direction Y, if the window is glazed. It is therefore a “portion for X-wise locking and Z-wise and Y-wise guiding”, called here “portion for locking” for simplification.

Note here that the glazed device of the invention implements two rails, for example one at the front the other at the rear, for a device intended to be mounted on a door or a lateral wall of a vehicle. Only one of these rails is provided with such a shoe according to the invention, for example at the rear for a front door, at the front for a rear door (the system would be hyperstatic if the front and rear shoes were X-wise locked).

According to the embodiments, the two shoes or only one of them have such a portion for ovoid locking.

According a particular embodiment, said portion for locking is substantially spherical. It can also be of a substantially spheroid shape.

According to a particular approach, said portion for locking is hollowed out in the central portion thereof, in such a way as to allow for the deformation thereof.

In particular, said portion for locking can have two symmetrical wings, separated by a groove extending along said longitudinal direction of said vehicle (X).

As such, when the wings are housed in the guide portion of the rail, they are stressed by the latter, and come closer to one another, while bracing against on the inner walls of the guide portion. The wings thus provide an effective X-wise locking, without opposing the sliding of the shoe.

Said wings can have a rib extending inside said groove.

This makes it possible to reinforce the wings, and to tend to return them to their rest position (position in the absence of stress).

Said connecting portion can have, on at least one of its faces, at least one guide boss in said guide portion of the rail, extending along the lateral direction (Y) of said vehicle.

This boss makes it possible to ensure a sufficient guiding in the rail, although of less quality that the one provided by the portion for X-wise locking, in case of deterioration, wear or breakage of the latter.

According a particular embodiment, said shoe is overmoulded on a metal insert.

Said overmoulding can in particular be carried out in polyoxymethylene (POM).

The invention also relates to such a guide shoe per se, for a glazed device intended to be assembled to a bodywork casing in order to form a motor vehicle door, said glazed device comprising at least one movable glazed panel that bears, on its face oriented towards the inside of the vehicle, at least two guide shoes each of which is mounted so as to slide with respect to a guide rail.

Said guide rail having a guide portion of substantially circular cross section, having a radius R1, that is open to allow the passage of a connecting portion of at least one of said shoes, said shoe has a portion for locking in the longitudinal direction of said vehicle (X), substantially ovoid and having a maximum radius R2 that is substantially greater than the radius R1, said locking portion being deformable so as to pass into said guide portion of the rail.

The invention further relates to motor vehicle doors, comprising a glazed device such as described hereinabove, as well as motor vehicles comprising at least one glazed device.

### DISCLOSURE OF THE FIGURES

Other characteristics and advantages of the invention shall appear more clearly when reading the following description of embodiments of the invention, given as simple and non-limiting examples for the purpose of information and annexed drawings among which:

FIGS. 1A and 1B show an example of a door according to the invention, with the movable portion being respectively in closed position and in open position;

FIG. 2 shows the glazed device of the door of FIGS. 1A and 1B;

FIG. 3 shows another example of a glazed device, seen from outside the vehicle, and having two shoes according to the invention;

FIG. 4 is a cross-section view of an upper portion of FIG. 3, showing in particular a shoe;

FIG. 5 is a cross-section view of the rail of FIG. 4;

FIG. 6 shows a partial view of the shoe of FIG. 4, and in particular the guide portion;

FIGS. 7A and 7B show the shoe of FIG. 6 assembled to a rail, respectively:

FIG. 7A: with the guide portion not inserted into the rail;

FIG. 7B: with the guide portion inserted into the rail.

### DETAILED DESCRIPTION OF EMBODIMENTS

The invention therefore relates to a motor vehicle door, and, in particular, the glazed portion thereof, which is flush, i.e. no frame or frame element is protruding towards the outside of the vehicle, in relation to the plane of this glazed portion.

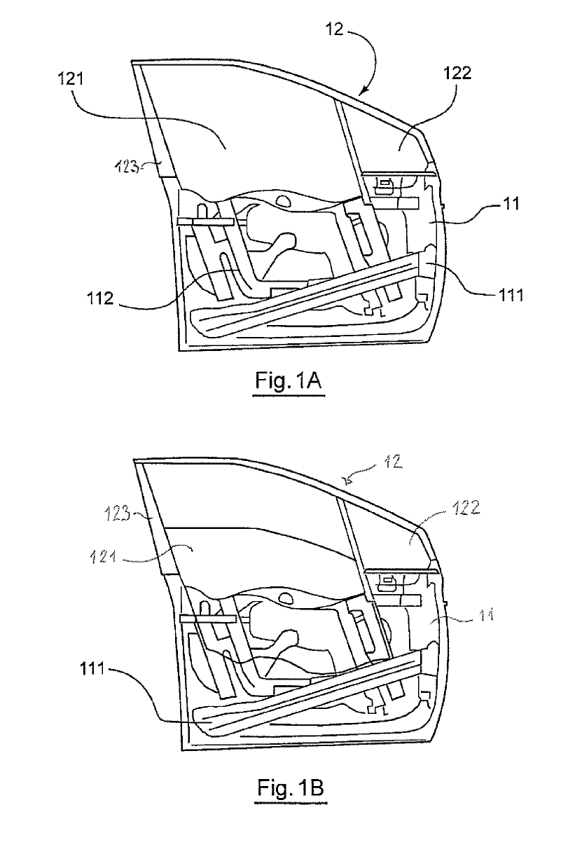

As shown in FIGS. 1A and 1B, the embodiment described hereinafter related to a front side door. However, of course, the same approach can be implemented on other doors of a vehicle.

This door conventionally comprises a lower portion 11, called a door case, forming the structure of this door. In the figures, the exterior element of the bodywork is omitted, in order to allow to appear the inside of this case, which comprises in particular a reinforcing upright 111, and elements 112 for receiving and maintaining the upper glazed portion.

The latter comprises a movable portion 121, that can be displaced from a closed position (FIG. 1A) to an open position (FIG. 1B). In the embodiment shown, it also comprises a fixed glazed element 122, corresponding here to the portion oriented towards the front of the vehicle. On the other side, towards the rear, a wheel cover 123 can be provided.

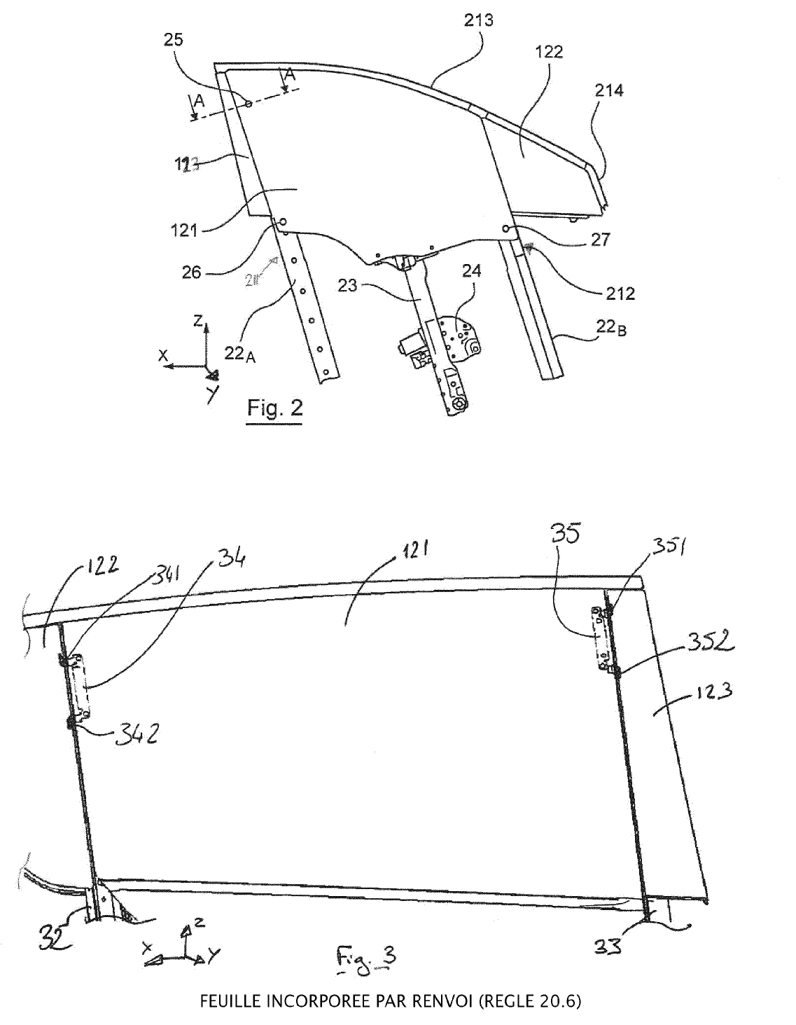

This glazed portion, or glazed device, 12 can be carried out independently, as shown in FIG. 2, and then assembled to the case 11, in order to form the door.

It comprises a frame 21, formed here from two uprights 211 and 212, each associated with a rail 22A, 22B, with an element 213 according to the curve of the upper portion of the glazed portion, and of a front element 214 associated with the fixed glazed portion 122. The frame can bear a seal. The upright 211 can bear the wheel cover 123.

The movable panel 121 is driven in displacement by driving means 23, for example a rack mechanism, itself actuated by an electric motor 24. Other driving means, including manual driving means, can of course be implemented.

In FIG. 2, the glazed portion is seen from the outside. It is observed that the frame 21 (in particular the uprights 211 and 212) extends under the movable panel 121, i.e. towards the inside of the vehicle. Guide shoes are fixed on the face of the movable panel 121 oriented towards the inside of the vehicle, in order to cooperate with the rails 22A, 22B. Of course, in practice, they are not generally visible from the outside (as the corresponding zone is screen printed), their positions are shown in FIG. 2. In this embodiment, two shoes 25 and 26 are provided to cooperate with the rail 22A oriented towards the rear, and a single shoe 27 is provided to cooperate with the rail oriented towards the front 22B.

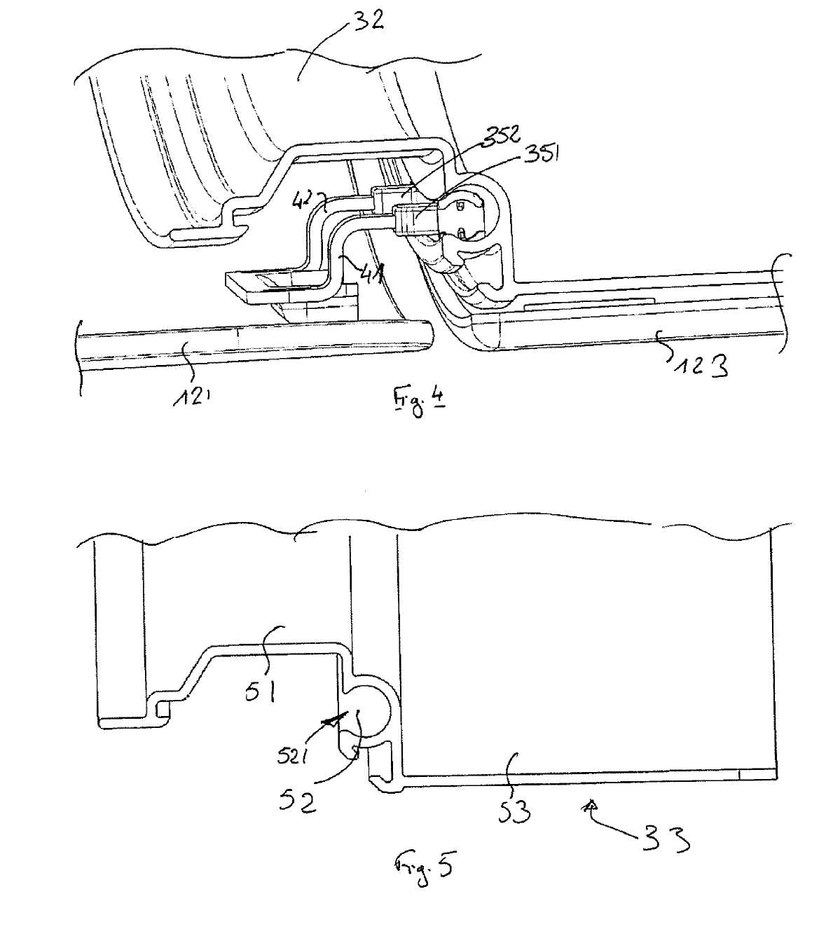

FIG. 3 shows an example of a glazed panel according to the invention, see from the outside. The shoes are shown as a dotted line, as they are seen by transparency. The movable portion 121, here in the closed position, is surrounded, on the left, by a fixed glazed portion 122, which could also be a wheel cover, and on the left by a wheel cover 123.

As this appears more clearly on the view as a partial cross-section of FIG. 4, the wheel cover 123 must be flush with the movable glazed panel 121, and the X-wise separation between the two parts must be controlled. For this, it is therefore important that the movable panel 121 not be displaced untimely according to this direction X, while still allowing of course for an effective Z-wise displacement (height of the vehicle), in order to open and close the window, as well as where applicable a Y-wise displacement, in order to follow the curve of the vehicle such as it appears, in the example shown, in FIG. 4 (which corresponds to the upper portion of the vehicle, with the window being closed).

In the embodiment shown in FIGS. 3 and 4, each guide rail 32, 33 is associated with a shoe 34, 35, fixed to the movable glazed panel 121 (for example according to the technique of patent document FR3021254) and each having two guide elements 341, 342 and 351, 352 respectively.

These guide elements (as well as an associated connecting portion) are formed, in particular overmoulded, on metal brackets 41, 42, which can be seen better in FIG. 4. The overmoulding is for example carried out in POM (polyoxymethylene).

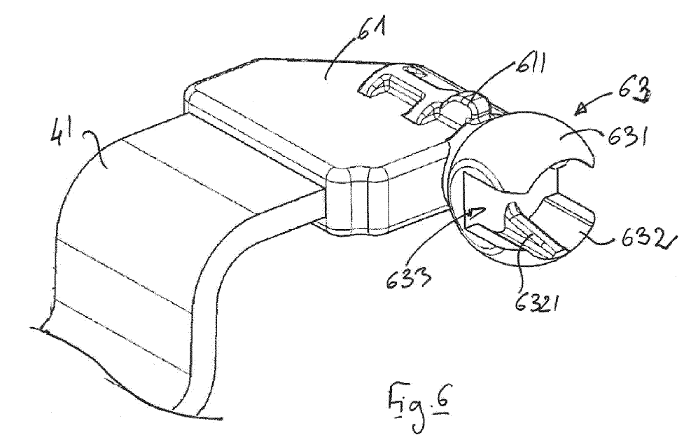

FIG. 5 shows, as a cross-section, an example of a rail according to the invention. It comprises in particular:
a zone 51 for securing to the chassis of the vehicle defining a space through which the shoes can be displaced;
a zone for guiding 52, able to cooperate with the guide portion or portions of a shoe. The cross-section of this guide portion 52 is substantially circular, with an opening 521 allowing for the passage of a connecting portion of the shoe;
a surface 53, whereon the wheel cover 123 can be added.

As shown in FIG. 4, the rail 33, and therefore all of the elements 51, 52 and 53 which constitute it, can be curved.

As mentioned hereinabove, in the embodiment shown, each shoe has two symmetrical guide elements 351, 352, each mounted on one of the metal brackets 41, 42 forming a reinforcing insert.

An example of a guide element 351 of a shoe is shown in FIG. 6.

The guide element comprises a connecting portion 61 overmoulded over the end of the metal bracket 41. The thickness of this connecting portion 61 is such that it can pass through the opening 521 of the guide portion 52 of the rail.

This connecting portion 61 bears a guide portion (in Y and in Z) and locking in X 63 of a substantially spherical shape, in this embodiment. More generally, this shape can be a substantially spheroid shape (olive shape), and even more generally a substantially ovoid shape. “Substantially” is indicated to define the shape, on the one hand because a minimum variation is acceptable, as long as the function is not modified, and on the other hand car this shape is truncated, in particular on the opening of the groove (space separating the two wings), as explained hereinafter, and where applicable on the securing with the connecting portion.

This sphere, or spheroid or ovoid shape, according to the cases, in indeed not materially complete, and is designed in such a way as to be deformable. It is hollowed out in the central portion thereof, and has two parallel wings 631, 632, separated by a central groove 633, according to the embodiment shown. This groove extends along an axis parallel to the direction X of the vehicle.

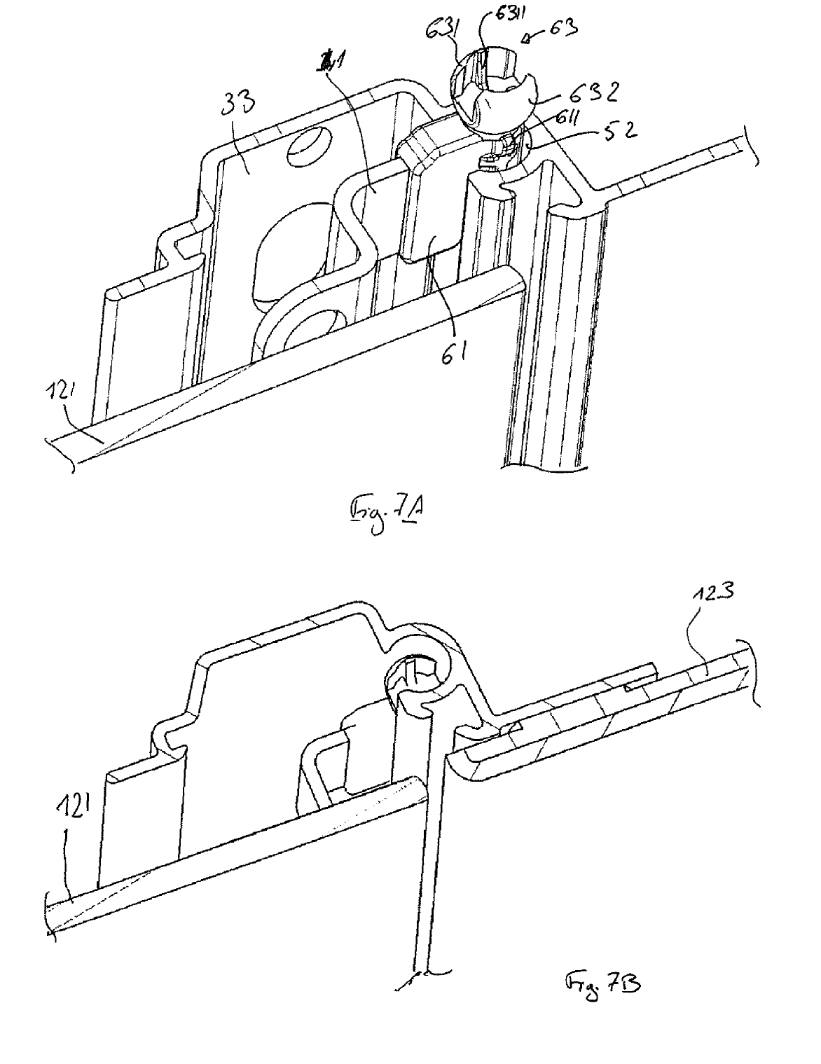

The radius R2 of this sphere (or the maximum radius if it is of ovoid shape) is slightly greater than the radius R1 of the guide portion 52 of the rail. This appears in particular in FIG. 7A, which shows the shoe partially inserted into the rail. It is observed that the wings 631 and 632 of the sphere occupy a space that is more important that the one defined by the rail.

As such, as shown in FIG. 7B, when these wings 631 and 632 are inserted, by force, into the rail, come closer to one another, which is made possible by the groove 633 and the flexibility of the wings 631 and 632.

In this way, the portion 63 is compressed along the direction Y, and blocked along the direction X. An X-wise locking of the shoe is obtained simply and effectively, without disturbance of the guiding of the shoes in Y and in Z.

In the embodiment shown, and as is shown in FIG. 6, each wing of sphere 631, 632 is associated with a rib 6311, 6321, which provides sufficient rigidity, and which tends to bring the wings 631 and 632 back against the edges of the rail.

The connecting portion 61 can moreover bear, on each one of these faces, a boss 611 that provides a replacement guiding, in the event of wear, deterioration or breakage of the wings 631, 632.

The X-wise locking of the shoe according to the invention applies only to a single rail, for example at the rear for a front door, at the front for a rear door. The system would indeed be hyperstatic if the front and rear shoes were X-wise locked.

It is possible to use one or two shoes for the X-wise locking. As such, according to an alternative implementation of the embodiment described, a single shoe for the X-wise blocking, for example the shoe 25 of FIG. 2, can be implemented. In this case, the shoe 26 can be replaced with an X-wise blocking abutment fixed on the rail 22A.

The rail 22B opposite the X-wise blocking has a section that is different from the rail 22A: the shoe 27, which can be identical to the shoe 25, slides, in this embodiment, in a mainly U shape, which allows it an X-wise displacement making it possible to offset the manufacturing and operating tolerances.

1. Glazed device intended to be assembled to a bodywork casing (11) in order to form a motor vehicle door, comprising at least one movable glazed panel (121) that bears, on its face oriented towards the inside of the vehicle, at least one guide shoe (25) each of which is mounted so as to slide with respect to a guide rail (22A),
characterised in that said guide rail (22A) has a guide portion of substantially circular cross section, having a radius R1, that is open to allow the passage of a connecting portion (61) of at least one of said guide shoes (25),
and in that at least one of said guide shoes has at least one portion (63) for locking in the longitudinal direction of said vehicle (X), substantially ovoid and having a maximum radius R2 that is substantially greater than the radius R1, said locking portion (63) being deformable so as to pass into said guide portion of the rail.

2. Device according to claim 1, characterised in that said portion (63) for locking is substantially spherical.

3. Device according to claim 1, characterised in that said portion (63) for locking is hollowed out in the central portion thereof, in such a way as to allow for the deformation thereof.

4. Device according to claim 3, characterised in that said portion (63) for locking has two symmetrical wings (631, 632), separated by a groove (633) extending along said longitudinal direction of said vehicle (X).

5. Device according to claim 4, characterised in that said wings (631, 632) have a rib (6311, 6321) extending inside said groove (633).

6. Device according to claim 1, characterised in that said connecting portion (61) has, on at least one of its faces, at least one guide boss (611) in said guide portion of the rail, extending along the lateral direction (Y) of said vehicle.

7. Device according to claim 1, characterised in that said shoe (25) is overmoulded on a metal insert.

8. Guide shoe of a glazed device intended to be assembled to a bodywork casing (11) in order to form a motor vehicle door, said glazed device comprising at least one movable glazed panel (121) that bears, on its face oriented towards the inside of the vehicle, at least one guide shoe (25) each mounted so as to slide with respect to a guide rail (22),
characterised in that, said guide rail (22A) having a guide portion of substantially circular cross section, having a radius R1, that is open to allow the passage of a connecting portion (61) of at least one of said guide shoes (25, 26), said guide shoe has a portion (63) for locking in the longitudinal direction of said vehicle (X), substantially ovoid and having a maximum radius R2 that is substantially greater than the radius R1, said locking portion (63) being deformable so as to pass into said guide portion of the rail.

9. Motor vehicle door, characterised in that it comprises a glazed device according to claim 1.

10. Motor vehicle, characterised in that it comprises at least one glazed device according to claim 1.
